(19) United States
(12) Patent Application Publication
(10) Pub. No.: US 2025/0030298 A1
(43) Pub. Date: Jan. 23, 2025

(54) STATOR ARRANGEMENT

(71) Applicant: BorgWarner Inc., Auburn Hills, MI (US)

(72) Inventors: Jonas Bickel, Mainz (DE); Andreas Köpper, Bürstadt (DE)

(21) Appl. No.: 18/777,808

(22) Filed: Jul. 19, 2024

(30) Foreign Application Priority Data
Jul. 21, 2023 (DE) 102023119336.8

(51) Int. Cl. H02K 3/52

(52) U.S. Cl. CPC H02K 3/522; H02K 2203/09

(57) ABSTRACT

A stator arrangement for an electric machine includes a stator comprising a stator core on which a stator winding has been arranged. The arrangement also includes an interconnection module for electrically interconnecting winding wire ends of the stator winding. The interconnection module is positioned on the stator on the end side. The interconnection module comprises integral electrical terminal conductors which are embedded at least partially in a body including an electrically insulating material. The terminal conductors each form a terminal contact to which an external power supply and/or control of the stator arrangement can be connected and a winding contact which is electrically conductively connected to a winding wire end.

### CROSS-REFERENCE TO RELATED APPLICATIONS

This application claims priority pursuant to 35 U.S.C. 119 (a) to German Patent Application No. 102023119336.8, filed Jul. 21, 2023, which application is incorporated herein by reference in its entirety.

### BACKGROUND

The invention relates to a stator arrangement for an electric machine, in particular an electric motor.

An electric motor can be used in vehicles, for example utility vehicles. The vehicle can have a drive which is an alternative to the internal combustion engine for fossil fuels in order to reduce carbon dioxide emissions. Such an electric drive can be fed, for example, by a fuel cell or a battery. One use area of an electric motor in vehicles is the cooling of the drive, battery or electronics. The electric motor drives a fan which cools the components. For this use, compact dimensions, even in the axial direction, and a high power are desirable.

A stator arrangement is part of an electric machine, for example an electric motor. The stator arrangement is a stationary part of the electric motor. The part of the electric motor which rotates within said stator arrangement is referred to as the rotor. The stator has a stator winding by means of which a time-variable magnetic field is induced by means of a time-variable current flow. In the case of operation with three AC voltages phase-shifted through 120 degrees, one winding phase is provided in the stator winding for each AC voltage.

In the case of the production of an exemplary conventional stator arrangement, each winding phase of the stator winding is wound with continuous wire along three stator teeth on one side of a stator core in one working step in order to form a pole. Then, the wire is passed onto the opposite side and wound along three stator teeth on the other side, which is offset through 180 degrees, in order to form a further pole. The passing of the wire between the groups of teeth takes place through an annular region of an end plate on the end side of the stator core. The annular region has laying channels for the wires between the poles on three step-like planes. Each plane is provided only for the wire of one phase and provides a sufficient air gap from intersecting wires of the other phases in order to achieve the required insulation between the wires on the annular region. This wiring takes place on the inwardly protruding, annular region behind the windings on the iron stator core and is accompanied by a greater inner diameter and therefore considerable material consumption for the iron stator core. In addition, the wiring has a poor thermal response in comparison with a water core for heat dissipation.

U.S. Pat. No. 10,763,723 B2 discloses a motor comprising a rotatable rotor, a stator facing the rotor, a busbar which is electrically connected to the stator, a busbar support for holding the busbar and a terminal bar having a first end which is electrically connected to the busbar. The terminal bar has a connection terminal at a second end which is to be electrically connected to the drive apparatus and a seal which is to be fastened to the drive apparatus and is arranged between the busbar and the connection terminal. The sealing section comprises a through-hole into which the terminal bar is pressed.

DE 10 2004 037 639 B4 discloses an electric motor which can be operated star-connected, wherein the star connection is implemented by means of the same winding machine as used for winding the polyphase winding onto the tooth.

There is the object of providing a stator arrangement having compact dimensions.

### SUMMARY

The object is achieved by a stator arrangement for an electric machine having a stator comprising a stator core on which a stator winding has been arranged and an interconnection module for electrically interconnecting winding wire ends of the stator winding. The interconnection module has been positioned on the stator on the end side. The interconnection module comprises integral electrical terminal conductors which are embedded at least partially in a body consisting of an electrically insulating material, wherein the terminal conductors each form a terminal contact to which an external power supply and/or control of the stator arrangement can be connected and a winding contact which is electrically conductively connected to a winding wire end.

Such a stator arrangement is advantageously provided for an electric motor. In the case of the stator arrangement, the stator winding is provided with a plurality of winding wires and the interconnection thereof separately and in various components. The interconnection module makes it possible to decouple the interconnection from the stator winding since the stator winding and the interconnection are provided in separate components. During the manufacture of the stator, only the stator winding is applied. Bridging wire guides between various poles are not provided. The interconnection of the winding wire ends takes place, however, by means of the separately manufactured and then positioned interconnection module to which the winding wire ends of the stator winding are connected.

The interconnection module is a functional component by means of which the interconnection of the stator winding is provided. It has conductors embedded in electrically insulating material. The conductors are advantageously surrounded completely by the material apart from their contacts, with the result that only the contacts are accessible. The conductors are advantageously metal. The conductors are formed integrally. They can be shaped, for example, from a metal sheet. Alternatively, contacts can be welded to the conductors at the end sides or connected in another way by material bonding in order to form the integral conductors. The electrically insulating material of the body in which the conductors are at least partially embedded is, for example, a plastic or a plastic mixture. The body insulates the conductors from one another and holds them in their position. The body consisting of an electrically insulating material can advantageously be a cast body, for example an injection-molded body, or an encapsulated body. Encapsulation envisages that the conductors are first positioned in a preinjected support component and aligned with respect to one another. In a further step, an encapsulating material is applied directly to the support component and conductors in which the support components and the conductors are at least partially embedded. The aforementioned formation of the embedment results in a materially bonded connection between the body and the conductor.

The embedment can also be realized in an alternative manner in that the conductor is inserted into the body. Such a body can have for example two parts, and the conductor is positioned between the joined-together components of the body in a cavity in order to at least partially embed it. Terminal contact and winding contact are accessible at the body exterior.

The conductors include terminal conductors having end regions in the form of terminal contacts for the external power supply and/or control, on the one hand, and winding contacts to which the winding wire ends of the stator winding are connected, on the other hand. The combination of a terminal contact for the external power supply and/or control and a winding contact in the terminal conductor as a leadframe reduces the production complexity.

The interconnection module provides terminal contacts for the external power supply and/or control of the stator arrangement which are connected directly to the terminal contacts. In contrast to a conventional arrangement in which the terminal contacts are provided as separate components, the production is simplified, and the terminal resistance is lower.

By virtue of the interconnection module which has been positioned on the stator on the end side, a narrow design with a minimal axial longitudinal extent is achieved. In the case of this package, the interconnection module, which is easy to manufacture, replaces the wire guidance in the case of a conventional winding scheme to be manufactured in non-automated fashion in which the winding wire is routed through trenches in an end plate between the poles. In addition to the advantage of modularity, the stator arrangement also enables quicker and automated manufacture which is suitable for mass production.

Advantageously, the interconnection module comprises integral electrical connecting conductors as further conductors which are each embedded at least partially in the insulating material of the body and form two winding contacts which are electrically conductively connected to winding wire ends. The electrical connection between two winding wire ends, for example for connecting mutually opposite two poles, takes place with these connecting conductors.

The winding wires of the stator winding are brought into contact, in one embodiment, for each pole via the interconnection module, with the result that each pole of the stator has two winding wire ends. The poles of the same winding phase are electrically connected by means of the interconnection module.

In one embodiment, three terminal contacts are provided which are phase terminal contacts for three winding phases, with the result that the stator can be operated with a three-phase alternating current.

In the case of a star connection, the three winding phases of the stator winding are connected to one another in the form of a star. The point at which they join is referred to as the star point or neutral point. In one embodiment, the interconnection module comprises an integral electrical star point conductor as conductor which is embedded at least partially in the casting material and forms three winding contacts which are electrically conductively connected to winding wire ends, with the result that the interconnection forms a star point. Alternatively, the three winding phases are delta-connected.

The combination of terminal conductors, connecting conductors and the star point conductor forms an interconnection in which the stator winding is connectable externally via the terminal contacts and has a plurality of poles and a star point.

The conductors which are embedded at least partially in the insulating material, whether it be the terminal conductors, the connecting conductors or the star point conductor, have end regions in which at least one side is exposed for contact-making in order to form the terminal contacts or the winding contacts. The other side is embedded in the material, with the result that the contact-making is flat and stable. Alternatively, the entire end region protrudes out of the body consisting of an insulating material. Electrical contact can be made with the exposed end regions by suitable force-fitting, form-fitting or materially bonded connections. If only one side of the end region is exposed, in particular soldering or welding is suitable. End regions protruding entirely out of the material can be in the form of piercing contacts or pin contacts. The latter is suitable in particular for the terminal contacts. The terminal contacts are advantageously in the form of sheet-metal sections which are rolled in the form of a pin or provided with edges and which protrude out of the casting material. Alternatively, the terminal contacts are in the form of contact lugs in sockets in the casting material. The sockets are cutouts in the body consisting of an insulating material, and the contact lugs are arranged on the walls of said sockets. The winding contacts can be in the form of piercing contacts, clamping contacts, soldered contacts or welded contacts. The piercing contact can be formed similarly to an insulation displacement connector (IDC). The provision of various contact types for winding contacts in the same interconnection module is also possible.

The conductors are advantageously in the form of stamped and bent parts which are simple to manufacture. The conductors are stamped from a metal sheet and then bent into their shape. This can include bending with which the end regions of the conductors are brought up to an upper side of the interconnection module or rolling in order to form pin-shaped terminal contacts which protrude out of the interconnection module. The conductor or at least a section of a conductor can be in the form of a stamped sheet-metal part, wherein the sheet is bent into its shape only when it is inserted into the body.

Advantageously, the interconnection module comprises a fastening means formed by the insulating material as an integral part of the body. The fastening means forms, with the stator, a force-fitting or form-fitting connection. This connection can be formed in particular with an end plate of the stator from an insulating material. The end plate has end caps and is arranged on the stator core on the end side. It keeps coils of the stator winding in their positions between winding space limits. In one embodiment, the fastening means comprises a clip which can be clamped onto the end plate or a stud which engages in a corresponding cutout in the stator. The prefabricated interconnection module can be plugged onto the end caps in a simple manner by virtue of studs on the interconnection module engaging in predetermined cutouts in end caps on the stator core. By virtue of the fastening means, the alignment of the interconnection module and the stator with respect to one another is also advantageously preset. Alternatively or in addition, coding means, for example an alignment groove in the stator core, can also be provided for this purpose.

In one embodiment, the interconnection module has an annular basic shape which is defined by the body consisting of an insulating material and in which the terminal conductors or the connecting conductors or the star point conductor run substantially in the form of a circular arc between the contacts. The contacts are conductor regions protruding out of the body and/or material-free regions which are accessible for contact-making.

In one embodiment, the winding contacts protrude radially into an inner region which is surrounded by the interconnection module and is provided for the rotor or are arranged on an end-side upper side of the interconnection module, with the result that the winding wire ends are passed onto the end side of the interconnection module for contact-making.

Advantageously, the terminal contacts protrude out of a base on the end-side upper side of the interconnection arrangement, with the result that power supply and control take place via the end side, which brings with it a compact design.

In one embodiment, the body comprises a main body with a trench for insertion of a conductor from the group with the terminal conductors, the connecting conductors and the star point conductor, or for insertion of a section of the conductor, and with a bottom which closes off the trench. Such a trench can run in the form of a circular arc. By way of stud-like holding means that protrude into the trench interior from side walls of the trench, the retention of the conductors can be improved. The conductors are held in a force-fitting and/or form-fitting manner by the holding means.

The inserted conductor or the inserted section is embedded between main body and bottom. In one embodiment, the terminal contacts are cast in the main body and are connected by material bonding to sections of the terminal conductors inserted in the trench so as to form integral terminal conductors.

The bottom can be in the form of a film, which is adhesively attached, or in the form of a ring composed of insulating injection-molding material, which is clipped on or adhesively attached to the main body. The latter embodiment is thicker and requires more axial installation space than the film.

An embodiment of the bottom, whether a film or a ring, with a continuous bottom surface not only prevents the conductors from falling out, but acts in the mounted state of the interconnection module, when it has been positioned on the stator, as an insulator in relation to the copper windings of the stator too. A bottom with a bottom surface which is not continuous, that is to say which has apertures in the bottom, acts substantially as a fall-out preventer for the conductors. The actual insulation in relation to the windings of the stator is achieved by a subsequent casting of the stator and of the interconnection module. In the case of a continuous bottom surface, there is no absolute need for the casting compound for this purpose.

### BRIEF DESCRIPTION OF THE DRAWINGS

Some exemplary embodiments will be explained in more detail below with reference to the drawing, in which:

FIG. 1 shows a three-dimensional view of an exemplary embodiment of a stator arrangement,

FIG. 2 shows a plan view of an exemplary embodiment of a stator,

FIG. 3 shows a winding scheme of an exemplary embodiment of a stator winding and the interconnection thereof,

FIG. 4 shows an exemplary embodiment of an interconnection module,

FIG. 5 shows a further exemplary embodiment of an interconnection module,

FIG. 6 shows yet a further exemplary embodiment of an interconnection module,

FIG. 7 shows a detail of the exemplary embodiment from FIG. 6,

FIG. 8 shows a detail from a further exemplary embodiment of an interconnection module,

FIG. 9 shows yet a further exemplary embodiment of an interconnection module,

FIG. 10 shows an exemplary embodiment of a main body, and

FIG. 11 shows the interconnection module in an exploded view.

Identical or functionally identical components are provided with the same reference signs in the figures.

### DETAILED DESCRIPTION

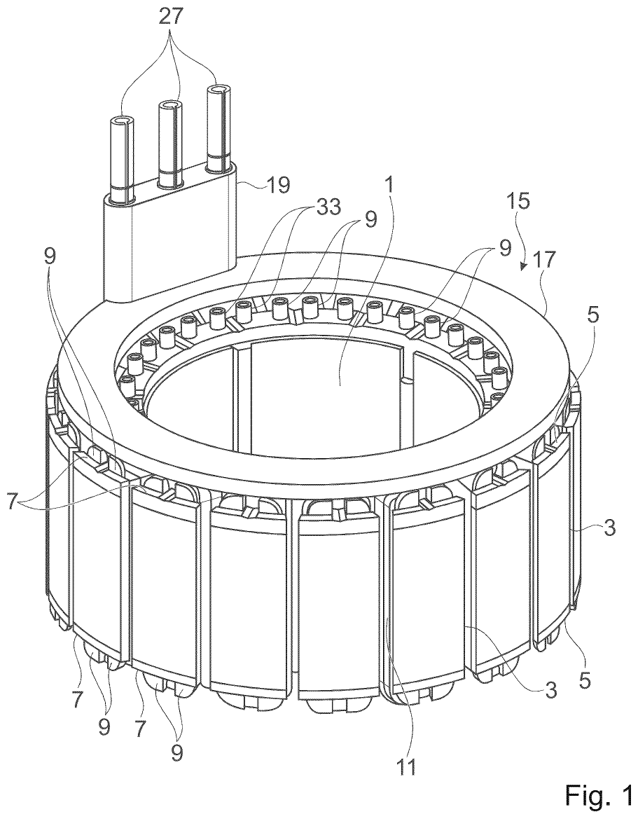

FIG. 1 shows, in a three-dimensional view, an exemplary embodiment of a stator arrangement. The stator arrangement comprises a stator core 1 having a laminate stack in which outwardly protruding stator teeth 3 are formed circumferentially. End plates 5 having a contour which corresponds at least substantially to the contour of the stator core 1 are arranged on the end sides of the stator core 1. The end plates 5 form end caps 7 on the stator teeth 3. The end plate 5 can have a multi-part design. The end caps 7 have inner and outer winding space limits 9, between which a coil of a stator winding 11 which runs over the stator tooth 3 is held and supported radially.

The stator winding 11 comprises a plurality of winding wires which are wound in each case in the form of a coil over one or more stator teeth 3. Winding wire ends 13 of these winding wires are electrically connected to one another via an interconnection module 15. The interconnection module 15 has been positioned on the stator and forms a form-fitting or force-fitting connection with it. For example, it is clipped, clamped or adhesively bonded.

The interconnection module 15 comprises conductors 21, 23, 25 (not illustrated in FIG. 1) which are embedded at least partially in a body 17 consisting of an insulating material. The contour of the annular body 17 corresponds to that of the stator, with the result that there is sufficient space for a rotor in the ring interior. In the schematic illustration in FIG. 1, no illustration of the winding wire ends 13 which are connected to the conductors 21, 23, 25 has been provided for reasons of clarity.

External control and power supply of the stator arrangement take place via terminal contacts 27 of the interconnection module 15. In this exemplary embodiment, the terminal contacts 27 have phase terminal contacts to which three phases of an AC power supply can be applied. The terminal contacts 27 are in the form of pin contacts protruding upwards in the axial direction out of a base 19.

During the manufacture of such a stator arrangement, winding and interconnection are decoupled since first the winding of the winding wires onto the stator teeth 3 takes place. Only then are the winding wire ends 13 interconnected by means of the interconnection module 15 by virtue of the winding wire ends 13 being electrically connected to winding contacts 29 of the interconnection module 15. As a result, the winding process is quicker since no transitions between various poles need to be laid during winding.

Once the interconnection arrangement has been positioned on the stator, the components are cast in order to achieve a permanent connection and to protect the components, in particular the stator winding 11. Beforehand, however, it is possible to replace one of the components in the case of a defect.

By virtue of the interconnection module 15 which is positioned on one of the end-side end plates 5, a narrow design with a minimal axial longitudinal extent is achieved which results in a compact package.

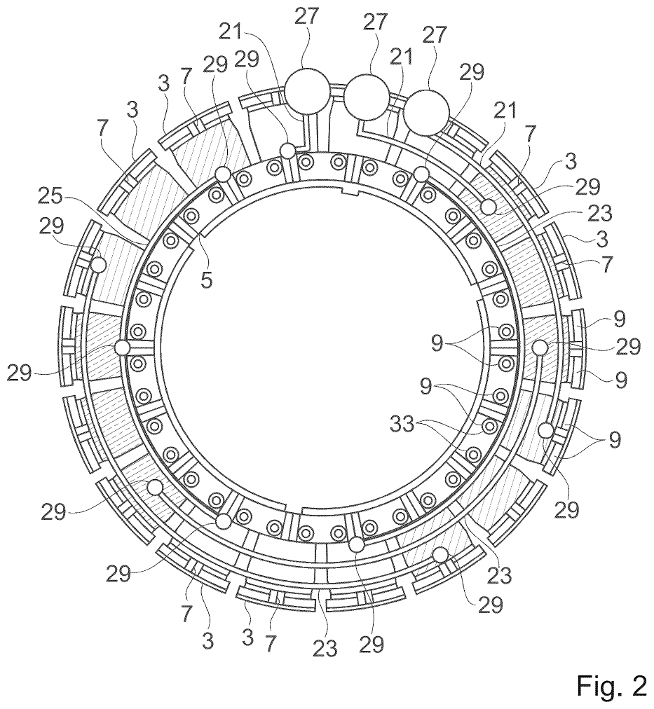

FIG. 2 shows a plan view of the stator and illustrates the course of the conductors and the positions of the contacts in the interconnection module 15 schematically. Further features of the interconnection module 15 are not illustrated in FIG. 2.

The stator is designed for three winding phases and in this exemplary embodiment comprises 18 stator teeth 3, of which in each case three adjacent stator teeth 3 are provided for one pole of the in total six poles. The two poles of the same winding phase are arranged opposite one another. The poles of the three winding phases are distinguishable by their hatching, wherein no hatching is provided for one winding phase. A winding wire runs over three stator teeth 3 of each pole. Each of the poles has two winding wire ends 13 which are electrically conductively connected to winding contacts 29 of the interconnection module 15.

End caps 7 formed by the end plate 5 are arranged on the stator teeth 3 for guiding and holding the stator winding 11. The end caps 7 have winding space limits 9 which protrude outwards as flanges in the axial direction and are hollow-cylindrical axial elevations 33 on the inside. The elevations 33 have yet a further function in addition to stabilization and holding of the stator winding 11. They are designed in such a way that studs on a lower side of the interconnection module 15 can engage in their cutouts and form a connection between the stator and the interconnection module 15. The interconnection module 15 in the form of a prefabricated leadframe ring is positioned on the end caps 7 of the stator. Only two studs are necessary for aligning and securely connecting the interconnection module 15. However, it is also possible for more studs to be provided in order to increase the stability of the connection.

The electrical connections in the interconnection module 15 take place by means of metal integral conductors 21, 23, 25 which are embedded at least partially in an insulating material (not illustrated in FIG. 2). The course of these conductors 21, 23, 25 and their contacts 27, 29 is illustrated schematically in FIG. 2.

The interconnection module 15 comprises three integral terminal conductors 21 as leadframes which have winding contacts 29 at one end and form the pin-shaped phase terminal contacts as terminal contacts 27 at the other end. The terminal conductor 21 runs, for each phase, from the terminal contact 27 to one of the poles of this winding phase. Contact is made with the other pole of the winding phase by an integral connecting conductor 23 as leadframe to which winding wire ends 13 of the two poles are connected. The still remaining winding wire ends 13 of the various winding phases are connected to one another to form a star point by a star point conductor 25 as leadframe. The winding wire ends 13 and the winding contacts 29 are provided on one of the outer stator teeth 3 of each pole. The conductors 21, 23, 25 for making contact with this pole conventionally run up to one of the outer stator teeth without crossing the other stator teeth of the same pole.

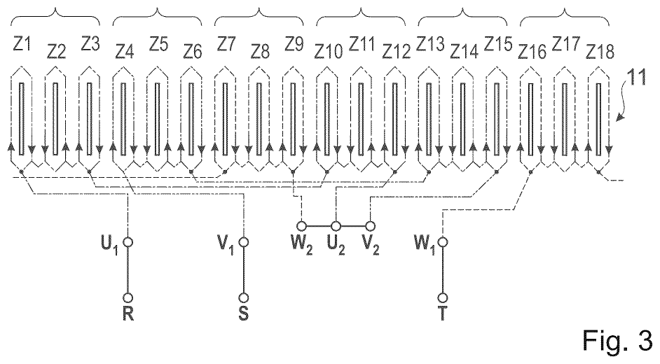

FIG. 3 shows, schematically, an exemplary winding scheme of an exemplary embodiment of a stator winding 11 and the electrical coupling by means of the interconnection module 15. Brackets illustrate in each case the winding section for a pole. The winding phase of the U phase runs over two poles on the first, second and third stator tooth Z1, Z2, Z3 and on the tenth, eleventh and twelfth stator tooth Z10, Z11, Z12. The terminal conductor, which is connected to the winding wire end U1 of the first stator tooth Z1, also forms the phase terminal contact R. A connecting conductor connects the winding wire ends of the third and tenth stator tooth Z3, Z10. The winding phase of the V phase runs over two poles on the fourth, fifth and sixth stator tooth Z4, Z5, Z6 and on the thirteenth, fourteenth and fifteenth stator tooth Z13, Z14, Z15. The terminal conductor which is connected to the winding wire end V1 of the fourth stator tooth Z4 also forms the phase terminal contact S. A connecting conductor connects the winding wire ends on the sixth and thirteenth stator tooth Z6, Z13. The winding phase of the W phase runs over two poles on the seventh, eighth and ninth stator tooth Z7, Z8, Z9 and on the sixteenth, seventeenth and eighteenth stator tooth Z16, Z17, Z18. The terminal conductor which is connected to the winding wire end W1 of the sixteenth stator tooth Z16 also forms the phase terminal contact T. A connecting conductor connects the winding wire ends of the seventh and eighteenth stator tooth Z7, Z18. A star point conductor connects the winding wire ends U2, V2, W2 on the ninth, twelfth and fifteenth stator tooth Z9, Z12, Z15 in order to form the star point of the interconnection.

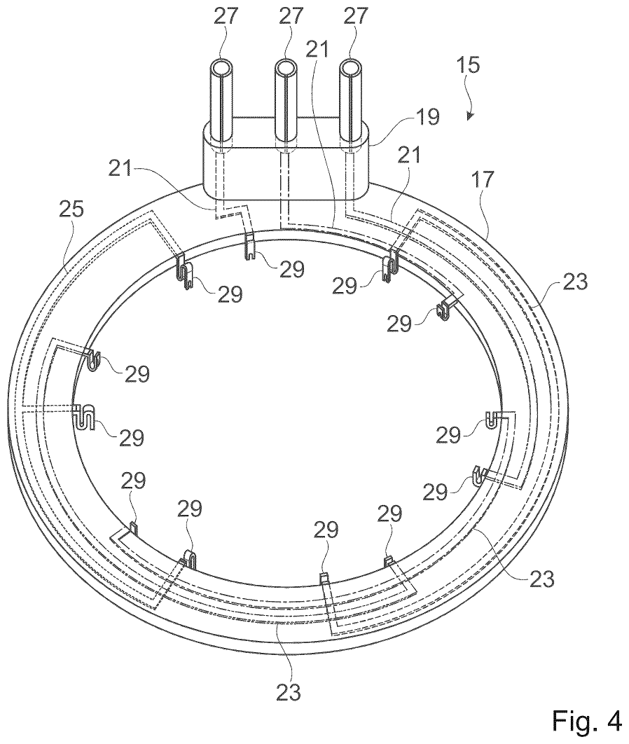

FIG. 4 shows an exemplary embodiment of an annular interconnection module 15 having a body 17 consisting of an insulating material in which terminal conductors 21, connecting conductors 23 and a star point conductor 25 are embedded apart from their end regions. The conductors 21, 23, 25 are held in their position and insulated from the other conductors by the material. The conductors 21, 23, 25 run, as has already been described in connection with FIG. 2, in order to electrically connect the poles of the winding phases and the phase contacts. The interconnection module 15 comprises, as leadframe ring, three terminal conductors 21 as leadframes, namely one for each phase. At the ends of the terminal conductors 21, the terminal contacts 27 are in the form of phase contacts which protrude as plug-type contacts axially out of a base 19 formed from the insulating material on the upper side of the ring. The other ends of the terminal conductors 21 protrude in the same way as the ends of the connecting conductors 23 and the ends of the star conductor 25 radially out of the body 17 into the ring interior and form winding contacts 29 which are formed in the form of a hook or in the form of an S, with the result that winding wire ends 13 can be suspended and are held by an elastic deformation of the hook-shaped or S-shaped winding contacts 29. A more secure connection can be achieved by optional soldering or adhesive bonding. The subsequent casting of the entire arrangement nevertheless finally fixes the connections and protects the stator with its stator winding 11 and the interconnection module 15.

The conductors 21, 23, 25 are stamped and bent parts having a basic shape which has been stamped out of a metal sheet and then deformed. The deformation substantially relates to the formation of the winding contacts 29, which are in the form of wire terminals for the winding wire ends 13, and the terminal contacts 27. The winding contacts 29 or the terminal contacts 27 can alternatively also be attached by soldering or welding in order to form an integral conductor.

The terminal contacts 27 are sheet-metal regions which have been hollow-cylindrically deformed and have a circular, oval or polygonal contour. In the case of the terminal conductor 21, a terminal contact 27 is provided at one end and a winding contact 29 is provided at the other end. The terminal conductors 21 are formed from a sheet-metal stamped and bent part. The as yet undeformed stamped part is configured in such a way that the in particular rectangular region forming the terminal contact 29 is part of the integral stamped part.

The conductors 21, 23, 25 run in the form of a circular arc and in radially offset fashion in order to prevent short circuits. The conductors 21, 23, 25 run, at least in regions, in different planes, with the result that sections which run radially inwards towards the winding contacts 29 and cross other conductors 21, 23, 25 do not touch the other conductors 21, 23, 25. Alternatively, an arcuate course of the crossing section over the other conductors 21, 23, 25 is possible.

During the production of the interconnection module 15, the conductors 21, 23, 25 are held, after the stamping and shaping, spaced apart from one another by a previously injected support component in their subsequent positions and then encapsulated. The resultant encapsulated body 17 fits onto the end caps 7 of the stator onto which it is positioned.

The above statements relating in particular to the conductors 21, 23, 25 also apply to the following exemplary embodiments, the description of which concentrates on differences in relation to this exemplary embodiment.

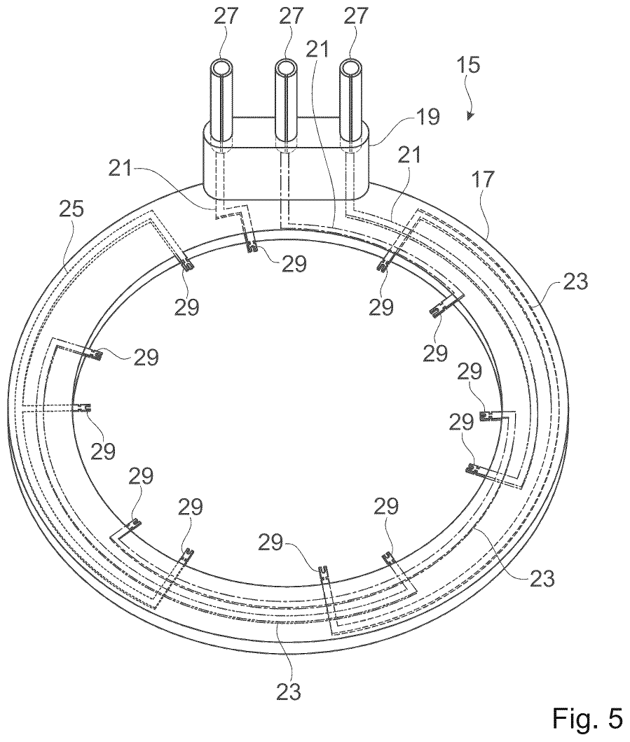

FIG. 5 shows a further exemplary embodiment of an annular interconnection module 15 which differs from the previous exemplary embodiment in terms of the winding contacts 29. The winding contacts 29 in this exemplary embodiment are in the form of tong-shaped piercing contacts. The winding wire ends 17 are pushed running axially into the piercing contacts which protrude into the ring interior.

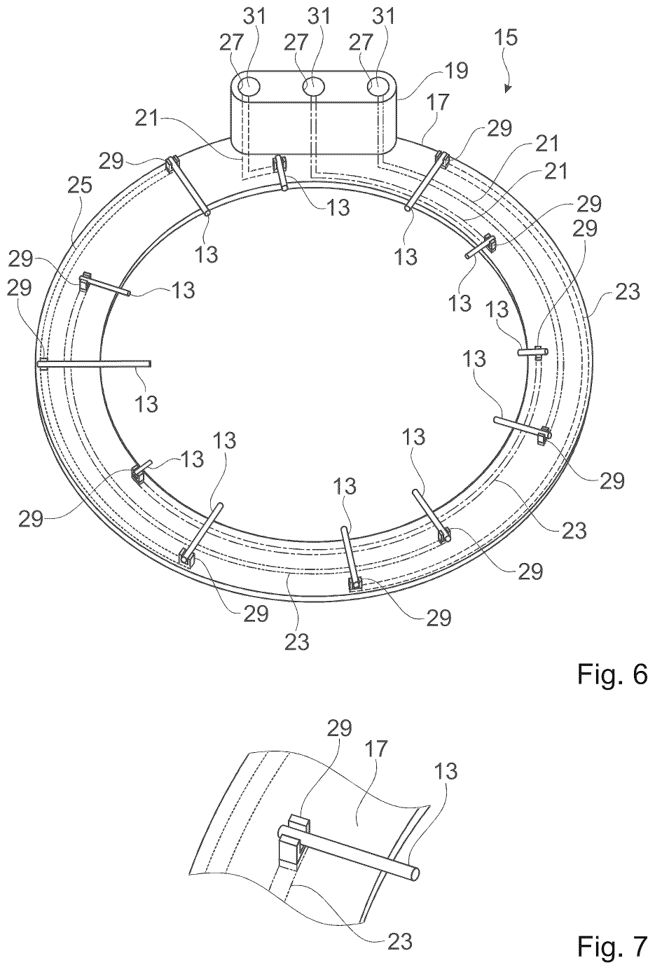

FIG. 6 shows a further exemplary embodiment of an annular interconnection module 15 which differs from the previous exemplary embodiments in terms of the winding contacts 29 and the terminal contacts 27. FIG. 7 shows a detail of the exemplary embodiment from FIG. 6 with a winding contact 29.

The terminal contacts 27 in this exemplary embodiment are in the form of sockets 31 in an axially upwardly protruding base 19 in the body 17 consisting of an insulating material. The terminal contacts 29 are end regions of the terminal conductors 21 which protrude as contact lugs into the sockets 31, where they are positioned on the socket walls and contact can be made therewith by external plug-type contacts.

The winding contacts 29 are positioned on the upper side of the interconnection module 15 and protrude axially out of the cast body 17. They are positioned adjacent to the stator teeth 3 at which the winding wire ends 13 are intended to be electrically connected to the winding contacts 29. Owing to the winding contacts 29 arranged on the upper side, the radially offset conductors 21, 23, 25 do not intersect one another in this exemplary embodiment. Since the conductors 21, 23, 25 are radially offset, the winding contacts 29 formed on the end side thereon are also radially offset. In order to make contact, the winding wire ends 13 are passed radially onto the upper side of the interconnection module 15 and inserted into the piercing contact as winding contact 29. A star point conductor is not provided.

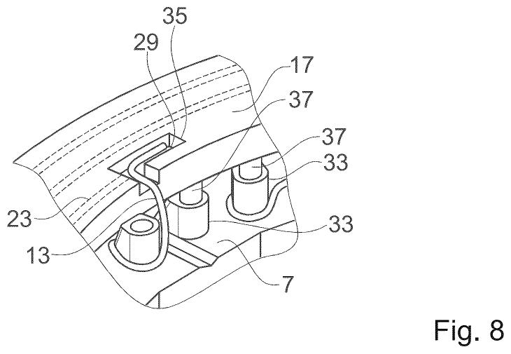

FIG. 8 shows a detail of a further exemplary embodiment of an interconnection module 15. In this exemplary embodiment, the contact-making of the winding wire ends 13 likewise takes place on the upper side of the interconnection module 15, namely by means of permanent welding of the winding wire end 13 on the exposed conductor end as winding contact 29. The interconnection module 15 has an L-shaped trench 35 which has arms arranged at right angles to one another. One arm runs along the conductor end which is accessible on the bottom of the trench. The other arm runs radially with respect to the ring interior. In order to make contact, the winding wire end 19 is threaded into the trench 19, with the result that it follows the course of the trench, and is welded to the conductor end. Each winding wire end 13 with which contact is to be made is welded to the winding contact 29 provided for this purpose of the leadframe geometry of the interconnection module 15. Alternatively, an IDC-like interface would also be possible.

In this exemplary embodiment, it can likewise be seen that hollow-cylindrical elevations 33 are provided on the end caps 7 which guide and hold the winding wire from and to the coils on the stator teeth. Studs 37 on the lower side of the interconnection module 15 can engage in the elevations in order to connect the interconnection module 15 and the stator.

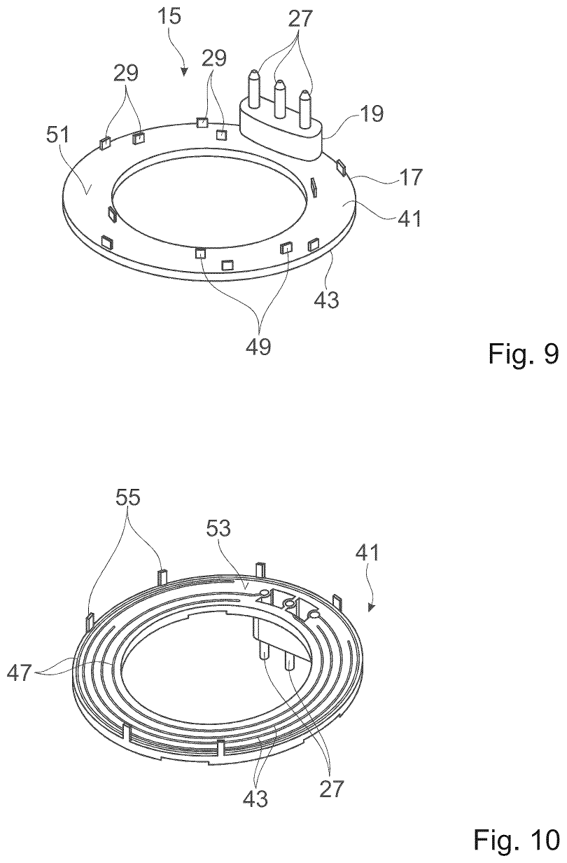

FIG. 9 shows, in a three-dimensional view obliquely from above, a further exemplary embodiment of an annular interconnection module 15 having a body 17 in which terminal conductors 21 and a star point conductor 25 are embedded at least partially. Optionally, it is also possible for connecting conductors 23 to be embedded at least partially. The interconnection is similar to or as in the above-described exemplary embodiments.

In this exemplary embodiment, the body 17 is formed in two pieces and has a main body 41 and a bottom 43. A star point conductor 25 and sections 61 of the terminal conductors 21 are inserted in the main body 41. The main body 41 is closed at the lower side by the bottom 43 in order to at least partially embed the conductors. The main body 41 can be an injection-molded component composed of plastic or of some other insulating material, and the bottom 43 can be a film composed of insulating material, for example a Teflon film, which is adhesively attached to the lower side 53 of the main body 41 and which covers the inserted conductors.

In this exemplary embodiment, the winding contacts 29 are in the form of rectangular sheet-metal lugs which protrude out of the main body 41 through slots 49 at the upper side. A connection to winding wire ends can be realized for example by soldering or ultrasonic welding.

The terminal contacts 27 are metal pins which protrude out of a base 19 which is formed on an upper side 51 of the main body 41. The base 19 is an integral part of the main body 41. The terminal contacts 27 are cast in the base 19 of the main body 41.

FIG. 10 shows a three-dimensional view of the main body 41 from FIG. 9 obliquely from below.

The main body 41 can be an injection-molded component composed of plastic which, on its structured lower side 53, has circular-arc-shaped trenches 47 in which sections 61 of the terminal conductors 21, possibly connecting conductors 23 and the star point conductor 25 are arranged. The trenches 47 receive the conductors (not illustrated in FIG. 10) and hold them in their position. The trenches 47 do not cross one another, with the result that the conductors are insulated from one another. Slots 49 in the trenches 47 that are continuous to the upper side 51 are provided for the winding contacts 29 in the form of sheet-metal lugs, with the result that, with conductors inserted, the winding contacts 29 project upward beyond the surface 51.

The trenches 47 have a radial spacing to one another that advantageously corresponds to the required insulation coordination, on the basis of clearance and creepage distance. Furthermore, on their side walls, the trenches 47 have studs as holding means, said studs clamping the sheet-metal-strip-shaped conductors and in this way holding them in their position. The studs are advantageously in the form of semicircular or hemispherical elevations which protrude from at least one of the oppositely situated side walls of the trench into the center of the trench. Such a formation is easy to realize in terms of injection molding. The studs can be attached to only one or to both oppositely situated side walls of the trench. In the latter case, the studs can be arranged situated oppositely or offset from one another. In one embodiment with a stud on a side wall, the oppositely situated side wall has a semicircular or hemispherical depression, resulting in a locally narrowly delimited curve in the course of the trench. The number of studs can vary, there advantageously being provided at least three studs for a conductor. When the conductors are inserted, these are pressed into the trenches 47 counter to a slight resistance by studs, wherein they and/or the studs undergo a deformation and the conductors consequently are held and remain in their position.

The cast metal pins of the terminal contacts 27 extend to the lower side 53.

Downwardly protruding connecting noses on the outer edge of the main body 41 are in the form of a clip 55, with the result that the subsequent interconnection module 15 is able to be positioned on the stator and is connected mechanically by means of a snap-fit connection.

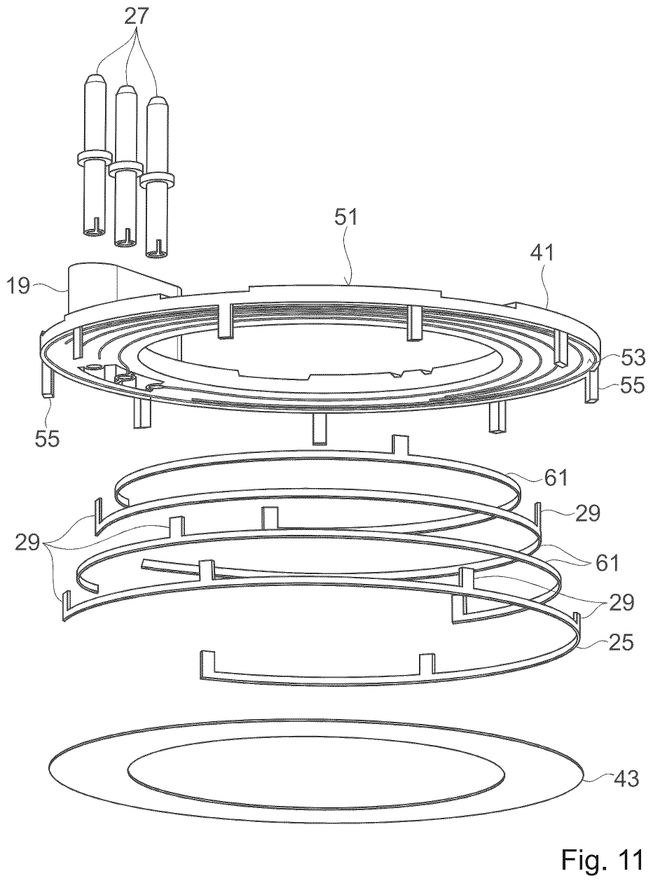

FIG. 11 shows an exploded illustration of the interconnection module 15 with the terminal contacts 27, in the form of phase terminal contacts, the main body 41, three sections 61 of terminal conductors 21, the star conductor 25 and the bottom 43.

The terminal contacts 27 are cast in the base 19 of the main body 41. The cross-sectional widening in the central region of the terminal contact 27 provides, with the terminal contact 27 cast, for secure retention. At the lower side, the terminal contacts 27 have connecting slots.

The sections 61 of terminal conductors 21 are in each case in the form of integral sheet-metal strips. Rectangular widenings of the sheet-metal strip form the sheet-metal lugs in the form of winding contacts 29.

The sheet-metal strips run perpendicularly to the upper side 51 of the main body 41 and are placed in a bent manner into the trenches 47. The sheet-metal strips can be pre-bent or bent only at the time of placement. The sheet-metal strips are placed in such a way that their winding contacts 29 protrude through the slots 49 and they engage in the bottom-side connecting slot of the terminal contacts 27. The conductive and materially bonded connection between the sections 61 of terminal conductors 21 and the terminal contacts 27 is realized for example by soldering, with the result that integral terminal contacts 21 are formed from the sheet-metal sections 61 and the pin-shaped terminal contacts 27.

Afterwards, the bottom 43 is fastened to the lower side 53 of the main body 41. The bottom 43 covers the sheet-metal strips placed in the trenches 47, with the result that they are embedded and cannot fall out.

The Teflon film, as bottom 43, has a continuous surface and, in the mounted state of the interconnection module 15 on the stator, even without casting compound, brings about sufficient insulation in relation to the copper windings on the stator. Nevertheless, this effect can be further supported by casting of the interconnection module 15 on the stator.

Such a multi-part body 17 can also have more than two parts. The winding contacts 29 can be formed in an alternative manner, for example as explained in relation to the previous exemplary embodiments.

The features specified above and in the claims and the features which can be gleaned from the figures can advantageously be realized both individually and in various combinations. The invention is not limited to the exemplary embodiments described but rather can be modified in many ways within the scope of the competence of a person skilled in the art.

### REFERENCE SIGNS

1 stator core
3, Z1 . . . Z18 stator tooth
5 end plate
7 end cap
9 winding space limit
11 stator winding
13, U1, U2, V1, V2, W1, W2 winding wire end
15 interconnection module
17 body
19 base
21 terminal conductor
23 connecting conductor
25 star point conductor
27 terminal contact
29 winding contact
31 socket
33 elevation
35 trench
37 stud
41 main body
43 bottom
47 trench
49 slot
51 upper side
53 lower side
55 clip
61 section
R, S, T phase terminal contact

1. A stator arrangement for an electric machine, the stator arrangement comprising:
a stator comprising a stator core on which a stator winding has been arranged,
an interconnection module for electrically interconnecting winding wire ends of the stator winding, wherein the interconnection module has been positioned on the stator on the end side,
characterized in that
the interconnection module comprises integral electrical terminal conductors which are embedded at least partially in a body comprising an electrically insulating material, wherein the terminal conductors each form a terminal contact to which an external power supply and/or control of the stator arrangement can be connected and a winding contact which is electrically conductively connected to a winding wire end.

2. The stator arrangement as claimed in claim 1,
characterized in that the interconnection module comprises one or more integral electrical connecting conductors which are each embedded at least partially in the body and form two winding contacts which are electrically conductively connected to the winding wire ends.

3. The stator arrangement as claimed in claim 1,
characterized in that each pole of the stator comprises two winding wire ends.

4. The stator arrangement as claimed in claim 1,
characterized in that three terminal contacts are provided which are phase terminal contacts (R, S, T).

5. The stator arrangement as claimed in claim 1,
characterized in that the interconnection module comprises an integral star point conductor which is embedded at least partially in the body and forms three winding contacts which are electrically conductively connected to winding wire ends, with the result that the interconnection forms a star point.

6. The stator arrangement as claimed in claim 5,
characterized in that a conductor which is embedded in the body from the group with the terminal conductors, the connecting conductors and the star point conductor has end regions which are exposed on at least one side and which are in the form of terminal contact or winding contact, wherein the winding contacts protrude radially into an inner region surrounded by the interconnection module or are arranged on an end-side upper side of the interconnection module.

7. The stator arrangement as claimed in claim 5,
characterized in that a conductor from the group with the terminal conductors, the connecting conductors and the star point conductor is in the form of a stamped and bent part or in the form of a stamped sheet-metal part or at least sectionally in the form of a stamped sheet-metal part.

8. The stator arrangement as claimed in claim 1,
characterized in that the body has a fastening means formed by the electrically insulating material which forms a force-fitting and/or form-fitting connection with the stator.

9. The stator arrangement as claimed in claim 1,
characterized in that the insulating material is an encapsulating material, an injection-molding material or a casting material.

10. The stator arrangement as claimed in claim 5,
characterized in that the body comprises a main body with a trench for insertion of a conductor from the group with the terminal conductors, the connecting conductors and the star point conductor, or for insertion of a section of the conductor, and comprises a bottom which at least partially closes off the trench.

11. The stator arrangement as claimed in claim 10,
characterized in that the terminal contacts are cast in the main body and are connected by material bonding to sections of the terminal conductors.

12. The stator arrangement as claimed in claim 1,
characterized in that at least one winding contact is in the form of a piercing contact, a clamping contact, a soldered contact or a welded contact.

13. The stator arrangement as claimed in claim 1,
characterized in that the terminal contacts are in the form of rolled or bent hollow-cylindrical sheet-metal sections which protrude out of the insulating material, or wherein the terminal contacts are in the form of contact lugs in sockets in the insulating material.

14. The stator arrangement as claimed in claim 6,
characterized in that the interconnection module has an annular basic shape in which the terminal conductors or the connecting conductors or the star point conductor run in the form of a circular arc.

15. The stator arrangement as claimed in claim 1,
characterized in that the terminal contacts protrude out of the base on an end-side upper side of the interconnection module.

16. The stator arrangement as claimed in claim 2,
characterized in that each pole of the stator comprises two winding wire ends.

17. The stator arrangement as claimed in claim 2,
characterized in that the interconnection module comprises an integral star point conductor which is embedded at least partially in the body and forms three winding contacts which are electrically conductively connected to winding wire ends, with the result that the interconnection forms a star point.

18. The stator arrangement as claimed in claim 6,
characterized in that a conductor from the group with the terminal conductors, the connecting conductors and the star point conductor is in the form of a stamped and bent part or in the form of a stamped sheet-metal part or at least sectionally in the form of a stamped sheet-metal part.
